(19) United States
(12) Patent Application Publication
(10) Pub. No.: US 2017/0328153 A1
(43) Pub. Date: Nov. 16, 2017

(54) SHEAR MECHANISM FOR BACK PRESSURE RELIEF IN CHOKES

(71) Applicant: Halliburton Energy Services, Inc., Houston, CA (US)

(72) Inventors: Travis David Watters, Flower Mound, TX (US); Craig Godfrey, Dallas, TX (US); Joseph Michael Karigan, Carrollton, TX (US)

(73) Assignee: Halliburton Energy Services, Inc., Houston, TX (US)

(21) Appl. No.: 15/526,931

(22) PCT Filed: Dec. 22, 2014
(86) PCT No.: PCT/US2014/071934

§ 371 Date: May 15, 2017

(51) Int. Cl. E21B 21/08; F16K 17/40; F16K 31/54; E21B 43/12; F16K 29/00

(52) U.S. Cl. CPC E21B 21/08; F16K 31/54; E21B 43/12; F16K 17/40; F16K 29/00

(57) ABSTRACT

A valve stem arrangement for use in an adjustable choke, the valve stem being configured to prevent damage to components of the adjustable choke during downstream overpressure conditions. The valve stem generally connects a valve gate to an actuator for moving the valve gate within the choke. A set of shear screws couple components of the valve stem together. During overpressure conditions, the shear screws shear, permitting retraction of the valve gate towards an open position, thereby relieving loads on various choke components.

### BACKGROUND

To control pressure and flow during drilling or production of hydrocarbon wells, operators may install a choke at the wellhead. Chokes generally include an inlet, an outlet, and some form of internal restriction between the inlet and outlet that maintains backpressure on the well and limits flow through the choke.

With adjustable chokes, the internal restriction is commonly a movable valve gate disposed within the choke between the inlet and the outlet. The valve gate is movable by an actuator between at least a fully open and a fully closed position. In the fully open position, flow between the inlet and the outlet is minimally restricted by the valve gate. In the fully closed position, on the other hand, the valve gate seats against a valve seat, blocking all flow through the choke. Although the fully open and fully closed positions define the full stroke of the valve gate, adjustable chokes typically permit positioning of the valve gate in intermediate positions between the fully opened and fully closed positions. When in an intermediate position, the valve gate partially limits flow through the choke while maintaining backpressure on the well. By changing the position of the valve gate to different intermediate positions, an operator can throttle flow through the valve and adjust backpressure on the well to fit drilling or production requirements.

Repositioning of the valve gate within the choke is typically accomplished by an actuator coupled to the valve gate by a valve stem. In some chokes, the actuator is a valve wheel, crank handle, or other manually operated structure. Other chokes may be equipped with actuators driven by hydraulic, pneumatic, electric, or other types of power and responsive to commands from a control system.

Chokes are commonly designed with the choke outlet being substantially perpendicular to the choke inlet and the valve gate arranged such that the valve gate moves along a path that is co-axial with the choke outlet. In such an arrangement, fluid pressure at the leading face of the valve gate is minimized as is the resulting axial load placed on the valve gate, valve stem, and actuator. As a result, during normal operating conditions, smaller and more cost-effective valve components may be used than if the valve gate were aligned otherwise.

Chokes are typically designed to withstand loading associated with normal operating conditions, but upset conditions in which operating conditions exceed their normal range may occur. For example, a downstream blockage or a failure of a downstream pressure relief or control valve may cause an increase in downstream pressure that exerts increased load on the valve gate, valve stem, and actuator. If the rise in downstream pressure is sufficient, the load may exceed the designed strength of the choke components, causing one or more of the components to fail.

Despite the resulting safety issues and downtime for such failures being undesirable, operators may find it impractical or cost prohibitive to install chokes capable of withstanding a full range of potential upset conditions. As a result, instead of opting for a potentially over-sized or over-designed choke, operators may find desirable a choke designed to fail in a predictable, controlled, and safe manner and that once failed, can be brought back into operation with minimal downtime.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features.

FIGS. 1A-C are cross-sectional views of a choke in accordance with one embodiment of this disclosure. Specifically, FIGS. 1A-C depict a choke in fully open, fully closed, and sheared states, respectively.

FIGS. 2A-B are cross-sectional views of a valve stem in accordance with one embodiment of this disclosure depicting the valve stem in unsheared and sheared states, respectively.

FIG. 3 is an isometric view of a valve stem according to an embodiment of this disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

The present disclosure relates generally to chokes and specifically to valve stems for use in chokes.

Illustrative embodiments of the present invention are described in detail herein. In the interest of clarity, not all features of an actual implementation may be described in this specification. It will of course be appreciated that in the development of any such actual embodiment, numerous implementation specific decisions must be made to achieve the specific implementation goals, which will vary from one implementation to another. Moreover, it will be appreciated that such a development effort might be complex and time consuming, but would nevertheless be a routine undertaking for those of ordinary skill in the art having the benefit of the present disclosure.

To facilitate a better understanding of this disclosure, the following examples of certain embodiments are given. In no way should the following examples be read to limit, or define, the scope of the claims.

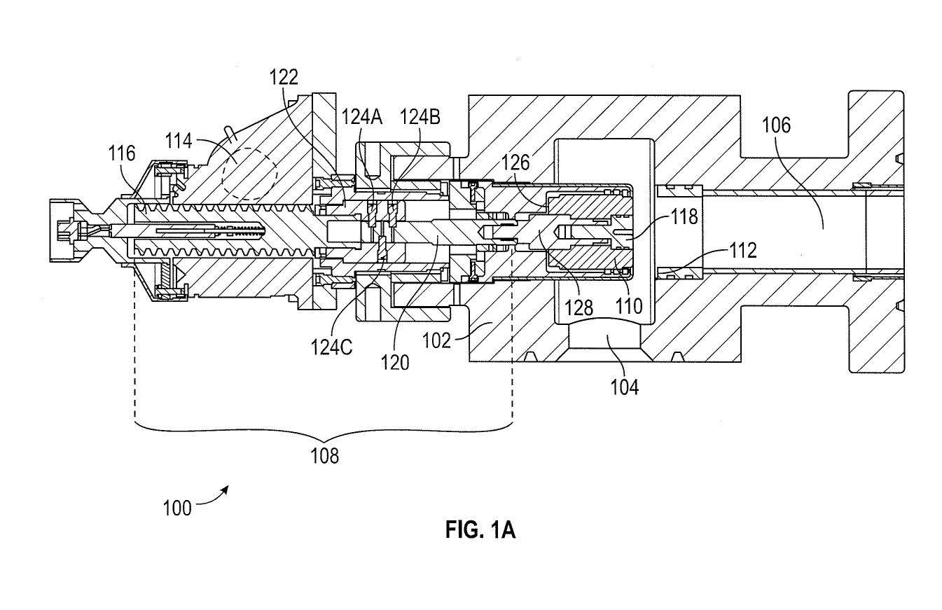

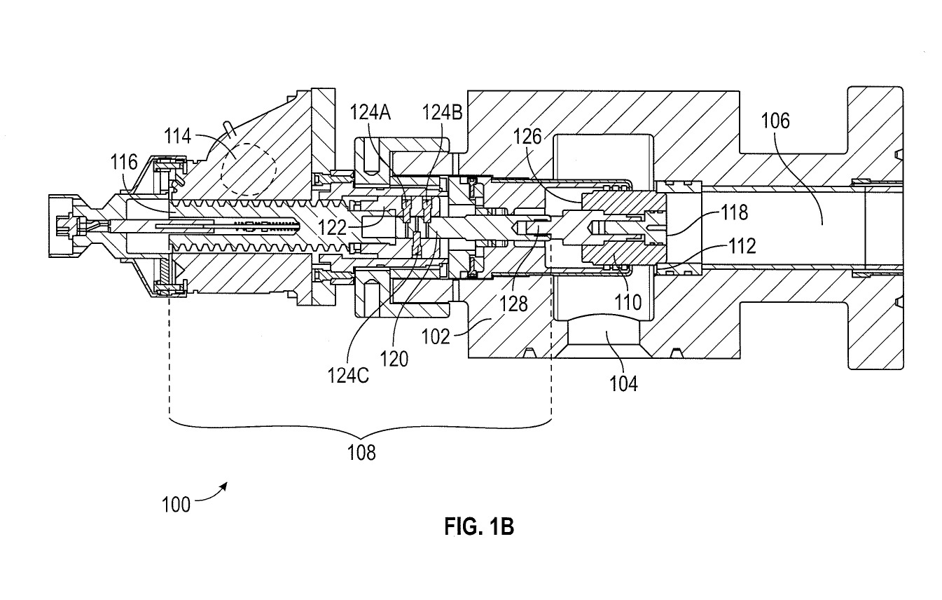

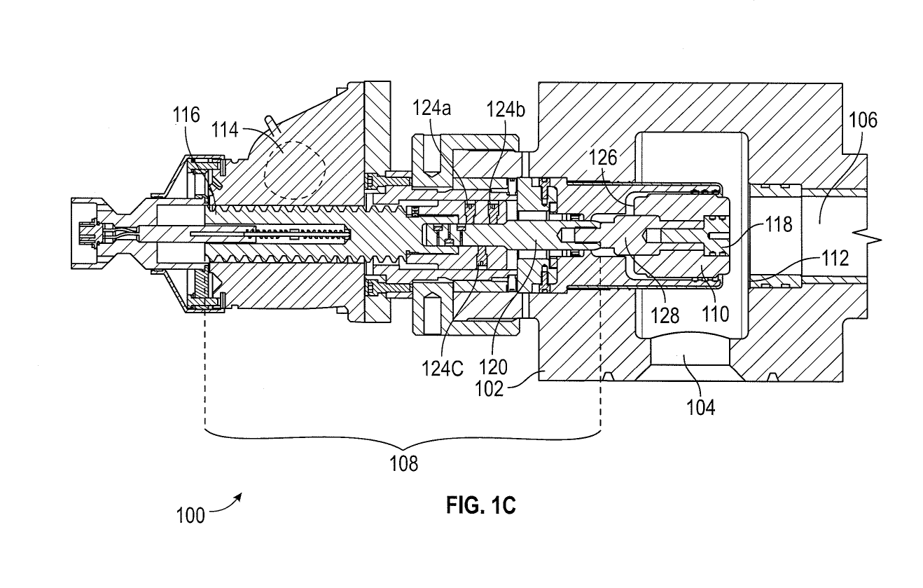

FIG. 1 depicts a choke 100 in accordance with one embodiment of this disclosure. Choke 100 includes a body 102 having an inlet 104 and an outlet 106. The inlet 104, outlet 106, and body 102 define a flow path through the choke 100 for fluid to flow from the inlet 104 to the outlet 106. Disposed within the body 102 between the inlet 104 and the outlet 106 is a valve gate 110.

Chokes, such as choke 100, are generally used to control back pressure and flow in a system. For example, chokes may be installed at a wellhead of a hydrocarbon-producing well to maintain backpressure on the well and control the amount of hydrocarbons produced from the well. Chokes, such as choke 100, generally operate by permitting high pressure fluid to enter the inlet 104, flow through the body 102, and exit the outlet 106. Valve gate 110, or a similar restriction, is disposed within the choke to restrict flow between the inlet 104 and the outlet 106.

The valve gate 110 may be stroked within the body 102 between an open position, as depicted in FIG. 1A, and a closed position, as depicted in FIG. 1B. In the closed position, the valve gate 110 abuts a valve seat 112 and prevents flow through the choke 100. In contrast, in the open position, the valve gate 110 is retracted away from the valve seat 112, minimizing the restriction created by the valve gate 110 between the inlet 104 and the outlet 106.

The valve gate 110 may be positioned in intermediate positions between the open position and the closed position such that the valve gate 110 partially restricts flow between the inlet 104 and the outlet 106. By varying the position of the valve gate 110 within the body 102, the degree of restriction created by the valve gate 110 and the resultant pressure drop and flow reduction across the choke 100 may be adjusted. Specifically, moving the valve gate 110 towards the open position reduces the restriction created by the valve gate 110, thereby reducing backpressure and increasing fluid flow through the outlet 106. Conversely, moving the valve gate 110 towards the closed position increases the restriction created by the valve gate 110, increasing backpressure and decreasing flow through the outlet 106.

The valve gate 110 is stroked between the first and the second position by an actuator 114 coupled to the valve gate 110 by a valve stem 108 that transmits motion of the actuator 114 to the valve gate 110. The actuator 114 may be any suitable actuator for moving the valve stem 108. For example, in manually actuated chokes, the actuator may be a handwheel, handle, crank, or similar manually operated structure for moving the valve stem 108. Alternatively, the actuator may include a drive mechanism for moving the valve stem 108 and may be actuated by hydraulic, pneumatic, electrical, or any other suitable type of power.

By way of example, FIGS. 1 A and 1B depict an embodiment in which the actuator 114 moves the valve gate 110 within the choke 100 by a worm drive. To do so, valve stem 108 includes a threaded actuator stem 116 that mates with a helical gear (not depicted) within the actuator 114. Rotating the helical gear by providing suitable power to the actuator 114, causes teeth of the helical gear to engage the threads of the actuator stem 116, moving the valve stem 108. In this arrangement, rotating the helical gears in a first direction causes the valve stem 108 to progress into the body 102, moving the valve gate 110 towards the closed position. Similarly, rotating the helical gear in a second direction opposite to the first direction causes the valve stem 116 to retract from the body 102, moving the valve gate 110 towards the open position.

During operation, fluid pressure at a leading face 118 of the valve gate 110 generates forces on the valve gate 110 towards the open position. When in the open position, as depicted in FIG. 1A, the valve gate 110 or other step feature may abut an internal surface of the body 102 or other choke components, such as stroke limit nut 122, transferring forces on the valve gate 110 to the body 102 or other choke component.

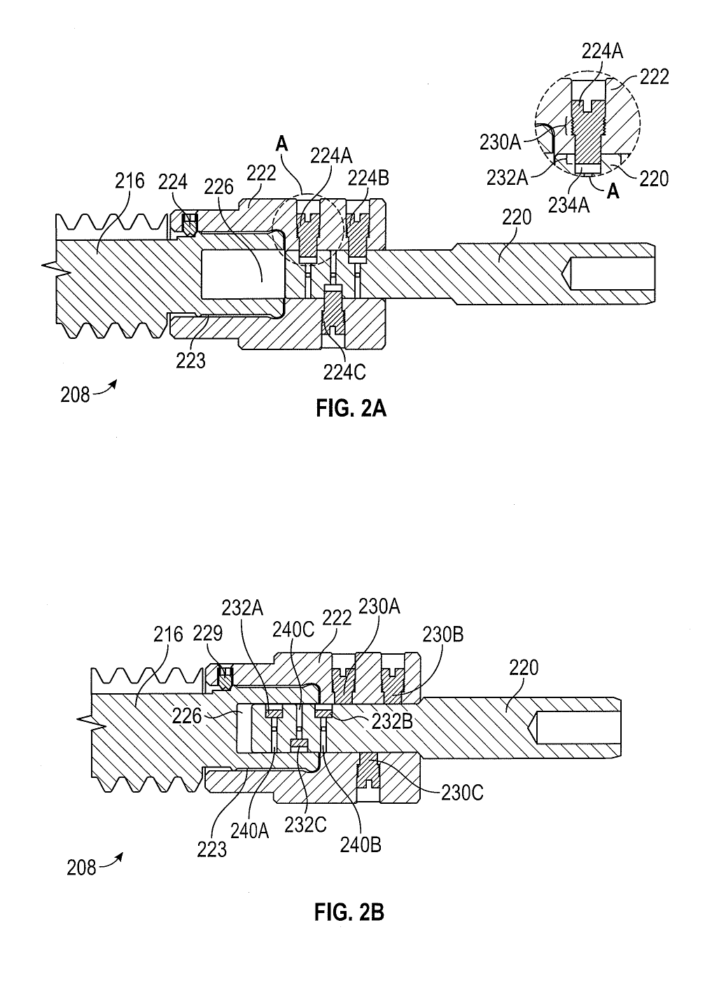

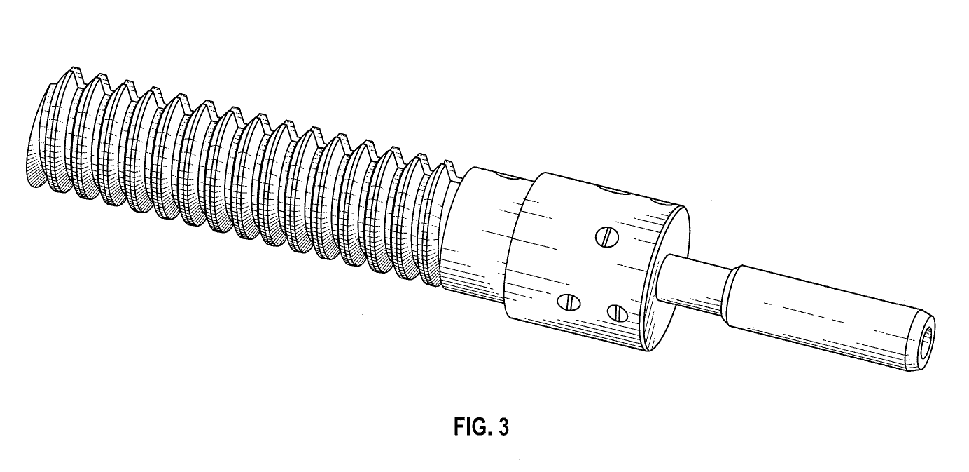

When the valve gate 110 is in the closed position, as depicted in FIG. 2B, or in any intermediate position between the open and closed positions, the force applied to the leading face 118 may be counteracted by an opposing force towards the closed position caused by fluid pressure within the choke acting on an opposite face 126 of the valve gate. However, because of a reduction in area of the opposite face 126 caused by the valve stem 108 and differences between fluid pressure within the body 102 and fluid pressure at the outlet 106, the two forces may not be balanced and a net force may be applied to the valve gate 110, resulting in an axial load on the valve stem 108 and other loads on components connected to the valve gate 110.

As depicted in FIGS. 1 A and 1B, the inlet 104 and the outlet 106 are substantially perpendicular to each other and the valve gate 110 is movable along an axis that is substantially co-axial with the outlet 106. Under normal operating conditions, fluid pressure is lower at the outlet 106 than at the inlet 104 due to the restriction created by the valve gate 110. As a result, forces on the valve gate 110 and the resulting axial load on the valve stem 108 may be minimized by orienting the leading face 118 of the valve gate 110 to be co-axial with the outlet 106. Further, due to the presence of downstream pressure control equipment, the pressure at the outlet 106 is generally more consistent and predictable than fluid pressure at the inlet 104, which may be subject to variations caused by changing well conditions.

Although a co-axial arrangement of the valve gate 110 and the outlet 106 minimizes axial loading during normal operating conditions when downstream pressure is relatively low, blockages in downstream piping, failure of downstream relief valves, and other abnormal conditions may cause an increase in downstream pressure. If the increase is sufficiently high, an overpressure event in which the resulting axial load exceeds the design strength of choke components may occur, causing the components to become damaged or catastrophically fail.

Under normal operating conditions, the restriction within the choke 100 created by the valve gate 110 maintains backpressure upstream of the choke 100. However, in downstream overpressure conditions, the restriction created by the valve gate 110 instead creates backpressure downstream of the choke 100. Because of this increase in downstream pressure, the axial load on the valve stem 108 may also increase during downstream overpressure conditions.

As previously discussed, backpressure maintained by the choke 100 may be reduced by moving the valve gate 110 towards the open position. As a result, one method of reducing damage to the actuator and other choke components from a downstream overpressure event is to permit movement of the valve gate 110 towards the open position when a downstream overpressure event occurs. Doing so reduces the restriction within the choke created by the valve gate 110, allowing downstream backpressure to escape upstream and reducing axial loading of the valve stem 108.

An alternative method of reducing the axial load on the valve gate 110 and actuator stem 120 during an overpressure event is to retract the valve gate 110 into a position in which the valve gate rests against the housing or other fixed valve components. Doing so transfers some of the axial load experienced by the valve gate 110 and actuator stem 120 to stronger valve components.

An overpressure event may also cause the valve seat 112 to retract with the valve gate 110. This retraction may be an unintended result of the overpressure event or the valve seat 112 may be configured to retract during an overpressure event. In certain embodiments, the valve seat 112 may be shaped such that in the retracted position, the valve seat 112 maintains a seal against both the valve gate 110 and the outlet 106, preventing fluid from travelling upstream of the valve 100. Accordingly, a retracting valve seat may be implemented in applications in which backflow to upstream equipment is undesirable.

As depicted in FIG. 1C, the valve stem 108 of choke 100 permits movement of the valve gate 110 towards the open position during overpressure events. Valve stems in accordance with this disclosure, such as valve stem 108, include an operator stem 120 coupled to the valve gate 110, a stroke limit nut 122 coupled to the actuator stem 116, and a plurality of shear screws 124A, 124B, and 124C, for coupling the operator stem 120 to the stroke limit nut 122.

Generally, during normal operating conditions, the shear screws 124A, 124B, and 124C maintain the operator stem 120 in a first position partially within a recess defined by the stroke limit nut 122 and the actuator stem 116. This first position is illustrated in FIGS. 1A and 1B.

The shear screws 124A, 124B, and 124C are selected such that when an overpressure event occurs, the shear screws 124A, 124B, and 124C shear, permitting retraction of the operator stem 120 into the recess. Because the operator stem 120 is coupled to the valve gate 110, retraction of the operator stem 120 into the recess also moves the valve gate 110 towards the open position, reducing axial loading on the valve stem 108 by relieving downstream backpressure or by transferring the axial loading to other valve components, as previously discussed.

Shearing of the shear screws 124A, 124B, and 124C and the effect of shearing on positioning of components of the valve stem 108 is illustrated by comparing FIG. 1B to FIG. 1C. As previously noted, FIG. 1B depicts the valve gate 110 in the closed position. If an overpressure were to occur with the valve gate 110 positioned in the closed position, the result would be choke 100 as depicts in FIG. 1C. Specifically, as depicted in FIG. 1C, shear screws 124A, 124B, and 124C have been sheared in response to the overpressure event, permitting retraction of the operator stem 120 into the recess defined by the stroke limit nut 122 and the actuator stem 116.

Operation of valve stems in accordance with this disclosure are further explained by referring to FIGS. 2A and 2B and their insets.

In accordance with this disclosure, FIGS. 2A and 2B depict an embodiment of a valve stem 208 in unsheared and sheared states, respectively. Valve stem 208 includes an actuator stem 216, coupled to a stroke limit nut 222 by threads 223 and maintained in position by a set screw 224. As depicted in FIG. 2A, the valve stem 208 also includes an operator stem 220 maintained within a recess 226 by shear screws 224A, 224B, and 224C.

Although FIGS. 2A and 2B depict actuator stem 216 and stroke limit nut 222 as two separate pieces, both components may be formed as a single piece. Alternatively, the stroke limit nut 222 may be coupled to the actuator stem 216 by a set screw or other fastener, a threaded connection, or by welding, brazing, shrink fitting, or any other suitable method for joining the stroke limit nut 222 to the actuator stem 216. Similarly, operator stem 220 may be coupled to a valve gate using any suitable means. In FIGS. 1A and 1B, for example, valve gate 110 is depicted as being coupled to operator stem 120 by a threaded coupling 128.

Returning to FIGS. 2A and 2B, Shear screws 224A, 224B, and 224C are selected to withstand axial loads applied to the valve stem 208 during normal operating conditions. Under such conditions, shear screws 224A, 224B, and 224C maintain operator stem 220 in a first position in which the operator stem 220 partially enters recess 226. When the shear screws 224A, 224B, and 224C shear in response to an overpressure event, operator stem 220 is permitted to retract further into recess 226. As depicted in FIGS. 2A and 2B, recess 226 is defined by the stroke limit nut 222 and the actuator stem 216 and extends into the actuator stem 216. However, in certain embodiments the recess 226 may be completely defined by the stroke limit nut 222 such that the recess does not extend into the actuator stem 216.

Referring now to FIG. 2A, each of shear screws 224A, 224B, and 224C are shouldered within stroke limit nut 222 and extend into operator stem 220. Detail A provides a more detailed view of shear screw 224A as installed and is exemplary of shear screws 224B and 224C. As shown in detail A, shear screw 224A may include a threaded portion 230A and an unthreaded portion 232A such that when shouldered within the stroke limit nut 222, the threaded portion 230A engages mating threads of the stroke limit nut 222 while the unthreaded portion 232A extends into a shear screw bore 234A in the operator stem 220. As further depicted in detail A, shear screw bore 234A may extend deeper into operator stem 220 than shear screw 224A, creating a clearance between the bottom of shear screw 224A and the bottom of shear screw bore 234A.

During operation of chokes in accordance with this disclosure, downstream pressure exerts a force on the valve gate. The force on the valve gate is transferred as an axial load on the operator stem 220, through the shear screws 224A, 224B, and 224C to the stroke limit nut 222, and to the actuator stem 216. Due to the coupling of the operator stem 220 to the stroke limit nut 222 by the shear screws 224A, 224B, and 224C, axial loads applied to the operator stem 220 result in shear stresses on each of the shear screws 224A, 224B, and 224C.

If the axial load and therefore the resulting shear stress on the shear screws 224A, 224B, and 224 is sufficiently high, the shear screws 224A, 224B, and 224C will shear, permitting retraction of the operator stem 220 further into the recess 226, as depicted in FIG. 2B. When sheared, the threaded portions 230A, 230B, and 230C of each shear screw are retained in the stroke limit nut 222 while the unthreaded portions 232A, 232B, and 232C are retained in shear screw bores in the operator stem 220.

During shearing, the threaded portions 230A, 230B, and 230C and/or the unthreaded portions 232A, 232B, and 232C may become deformed or develop burrs or similar rough edges that obstruct movement of the operator stem 220 into the recess 226. To reduce the likelihood of such obstructions, clearance may be provided in the shear screw bores such that the unthreaded portions 232A, 232B, and 232C of the shear screws drop into the shear screw bores after shearing. The shear screw bores may include a beveled entrance to guide the unthreaded portions 232A, 232B, and 232C into the shear screw bores. Alternatively or in addition to the beveled entrance, the diameter of recess 226 may be such that clearance exists between the walls of the recess 226 and the operator stem 220 when the operator stem retracts into the recess 226.

After a downstream overpressure event resulting in shearing of the shear screws has occurred, the valve stem must be repaired before the choke can be returned to service. Repair of the valve stem generally involves removing the valve stem from the choke, removing the portions of the sheared shear screws from the stroke limit nut and the operator stem, installing new shear screws, and then replacing the valve stem within the choke.

The steps to remove the valve stem from the choke are not within the scope of this disclosure and will vary based on the specific arrangement of the choke and its components. However, removal of the valve stem from the choke generally involves partial disassembly of the choke to permit access and removal of the valve stem. Disassembly and replacement of the valve stem may also require decoupling the valve stem from the actuator and decoupling of the operator stem from the valve gate.

Repair further requires decoupling of the stroke limit nut and operator stem. This may occur after the valve stem has been removed from the choke or as part of the disassembly process. Because the shear screws coupling the stroke limit nut to the operator stem have been sheared, disassembly of the stroke limit nut and operator stem generally involves sliding the operator stem out of the recess. Once the valve stem and stroke limit nut are separated, the portions of the shear screws retained in the stroke limit nut and the operator stem may be removed. Threaded portions of the shear screws retained in the stroke limit nut after shearing may be removed from the stroke limit nut by backing out the threaded portion using a screwdriver, hex key, or other appropriate tool for counter-rotating the threaded portion. One of ordinary skill in the art would appreciate that the shear screws may be designed to be driven or removed by any tool suitable for driving or removing screws or bolts. Preferably, the shear screws include heads having standard shapes and sizes, permitting installation and removal using standard, readily available tools.

The unthreaded portions of the shear screw may simply fall out of the shear screw bores when the operator stem is separated from the stroke limit nut. However, in some cases the unthreaded portions of the shear screws may be deformed as they are sheared, causing them to become stuck within the shear screw bores. Depending on the nature of the deformation, the unthreaded portion may be removed by inserting a screwdriver or other tool into the shear screw bore and prying the unthreaded portion out of the shear screw bore. However, doing so may not be possible or may not be possible without damaging the operator stem. As an alternative, and as depicted in FIG. 2B, through holes 240A, 240B, and 240C may extend from the bottom of each shear screw bore through the operator stem, permitting insertion of a punch, a rod, or a similar tool to facilitate removal of the unthreaded portion.

Once the sheared shear screws have been removed, the valve stem can be reassembled by reinserting the operator stem into the stroke limit nut such that the shear screw bores align with the shear screw locations of the stroke limit nut. Once aligned, the operator stem can be recoupled to the stroke limit nut by installing a new set of shear screws using a screwdriver, hex key, or other appropriate tool for rotating the shear screws.

Although the previously discussed embodiments depict valve stems having three shear screws, embodiments according to this disclosure are not limited to three-shear-screw configurations. Any number or arrangement of shear screws may be used to secure the stroke limit nut to the operator stem provided that the shear screws are sufficiently strong to withstand shear stresses applied to the shear screws during normal operating conditions and selected to shear when an overpressure event occurs. The particular quantity and shear strength of the shear screws used in any embodiment will be dependent on the specific operating conditions under which the choke is to be used and the strength of other choke components to be protected during overpressure conditions. For example, if a threaded section of the valve stem is particularly susceptible to damage during overpressure events, the quantity and strength of the shear screws may be selected such that the combined shear strength of the shear screws is lower than that of the threaded section. As a result, during an overpressure event, the shear screws will shear before the threaded section is damaged.

One of ordinary skill having the benefit of this disclosure would appreciate that embodiments disclosed herein may be incorporated in new chokes or may be used to retrofit existing chokes. For example, valve stems in an existing choke may be replaced with valve stems in accordance with this disclosure. Similarly, valve stems of embodiments disclosed herein may also be removed and reused in multiple valves over the useful life of the valve stem. Incorporation of embodiments disclosed herein into existing valves may require modification or alteration of the existing choke to accommodate valve stems in accordance with this disclosure, but any such modifications would be within the abilities of one skilled in the art having the benefit of this disclosure.

Although numerous characteristics and advantages of embodiments of the present invention have been set forth in the foregoing description and accompanying figures, this description is illustrative only. Changes to details regarding structure and arrangement that are not specifically included in this description may nevertheless be within the full extent indicated by the claims.

What is claimed is:

1. An apparatus comprising:
a body, the body further comprising an inlet and an outlet and defining a flow path within the body between the inlet and the outlet;
a valve gate movable within the housing along a path substantially coaxial with the outlet;
an actuator for moving the valve gate within the housing along the path substantially coaxial with the outlet; and
a valve stem coupling the actuator to the valve gate, the valve stem comprising,
an actuator stem coupled to the actuator;
an operator stem coupled to the valve gate;
a stroke limit nut disposed on the actuator stem and coupled to the operator stem, wherein the stroke limit nut is coupled to the operator stem by one or more shear screws; and
a recess defined within the valve stem such that when the one or more shear screws are unsheared, the operator stem is maintained in a first position, and when the one or more shear screws are sheared, the operator stem is permitted to move into a second position, the second position being further within the recess than the first position.

2. The apparatus of claim 1, wherein
the recess extends at least partially into the actuator stem.

3. The apparatus of claim 1, wherein
the one or more share screws are designed to shear when a predefined pressure is exerted on the valve gate.

4. The apparatus of claim 1, wherein
the one or more shear screws comprise a threaded portion and an unthreaded portion such that when the one or more shear screws are unsheared, the threaded portion engages a set of mating threads of the stroke limit nut and the unthreaded portion extends into the operator stem.

5. The apparatus of claim 1, wherein
the operator stem comprises one or more bores coaxial with the one or more shear screws, the one or more bores receiving at least a portion of the one or more shear screws and extending past the one or more shear screws when the one or more shear screws are unsheared.

6. The apparatus of claim 5, wherein
the operator stem comprises a through-hole axially aligned with the one or more bores.

7. The apparatus of claim 11, wherein
the stroke limit nut is coupled to the actuator stem by one of the group of a fastener, a threaded connection, welding, brazing, or shrink fitting.

8. The apparatus of claim 11, wherein
the actuator stem and the stroke limit nut form a unitary assembly.

9. The apparatus of claim 1, wherein
the one or more shear screws comprise a head having a size and shape configured to allow installation or removal of the one or more shear screws using a standard tool for driving or removing screws or bolts.

10. The apparatus of claim 1, wherein
the valve stem is selected from the group of a replacement valve stem for a valve stem previously installed in the apparatus and a valve stem previously installed in a second apparatus.

11. A valve stem for use in a choke valve, comprising:
an actuator stem suitable for connection to and actuation by an actuator;
an operator stem suitable for coupling to a valve gate within the choke valve;
a stroke limit nut disposed on the actuator stem and coupled to the operator stem, wherein the stroke limit nut is coupled to the operator stem by one or more shear screws; and
a recess defined within the valve stem such that when the one or more shear screws are unsheared, the operator stem is maintained in a first position, and when the one ore more shear screws are sheared, the operator stem is permitted to move into a second position, the second position being further within the recess than the first position.

12. The valve stem of claim 11, wherein
the recess extends at least partially into the actuator stem.

13. The valve stem of claim 11, wherein
the one or more shear screws are designed to shear when a predefined pressure is exerted on the valve gate.

14. The valve stem of claim 11, wherein
the one or more shear screws comprise a threaded portion and an unthreaded portion such that when the one or more shear screws are unsheared, the threaded portion engages a set of mating threads of the stroke limit nut and the unthreaded portion extends into the operator stem.

15. The valve stem of claim 11, wherein
the operator stem comprises one or more bores coaxial with the one or more shear screws, the one or more bores receiving at least a portion of the one or more shear screws and extending past the one or more shear screws when the one or more shear screws are unsheared.

16. The valve stem of claim 15, wherein
the operator stem comprises a through-hole axially aligned with the one or more bores.

17. The valve stem of claim 11, wherein
the stroke limit nut is coupled to the actuator stem by one of the group of a fastener, a threaded connection, welding, brazing, or shrink fitting.

18. The valve stem of claim 11, wherein
the actuator stem and the stroke limit nut form a unitary assembly.

19. The valve stem of claim 1111, wherein
the one or more shear screws comprise a head having a size and shape configured to allow installation or removal of the one or more shear screws using a standard tool for driving or removing screws or bolts.

20. The valve stem of claim 11, wherein
the valve stem is configured to replace a second valve stem previously installed in a choke valve.
